(19) United States
(12) Patent Application Publication
(10) Pub. No.: US 2002/0174417 A1
(43) Pub. Date: Nov. 21, 2002

(54) Defining and creating custom data fields within process management software

(76) Inventors: Michael Sijacic, Sunnyvale, CA (US); Edwin Khodabakchian, Sunnyvale, CA (US); Albert Tam, Sunnyvale, CA (US); Michal Chmielewski, San Jose, CA (US)

Correspondence Address: ROSENTHAL & OSHA L.L.P., 1221 MCKINNEY AVENUE, SUITE 2800, HOUSTON, TX, 77010, US

(21) Appl. No.: 09/823,001

(22) Filed: Mar. 30, 2001

(51) Int. Cl. G06F 9/45

(52) U.S. Cl. 717/147

(57) ABSTRACT

A method of creating and defining a custom data field within a process management system includes creating a file to specify visible field properties of the custom data field and defining a model of the custom data field. The file and the model may be packaged into an archive file. The custom data field may be inserted and the archive file is added into the process management system as a new class. The process management system may be deployed with the new class and the process management system may be tested with the new class.

### BACKGROUND OF INVENTION

The basic functionality of a computer is dictated by the type of operating system (OS) it uses. Various OS exist in the market place, including Solaris™ from Sun Microsystems Inc., Palo Alto, Calif. (Sun Microsystems), Macintosh® from Apple Computer, Inc., Cupertino, Calif., Windows® 95/98 and Windows NT®, from Microsoft Corporation, Redmond, Wash., and Linux. The combination of an OS and its underlying hardware is referred to herein as a “traditional platform”. Prior to the popularity of the Internet, software developers wrote programs specifically designed for individual traditional platforms with a single set of system calls and, later, application program interface (APIs). Thus, a program written for one platform could not be run on another. However, the advent of the Internet made cross-platform compatibility a necessity and a broader definition of a platform has emerged. Today, this original definition of a traditional platform (OS/hardware) dwells at the lower layers of what is commonly termed a “stack,” referring to the successive layers of software required to operate in an environment presented by the Internet and World Wide Web.

Prior art FIG. 1 illustrates a conceptual arrangement wherein a first computer (2) running the Solaris™ platform and a second computer (4) running the Windows® 98 platform are connected to a server (8) via the Internet (6). A resource provider using the server (8) might be any type of business, governmental, or educational institution. The resource provider (8) has a need to be able to provide its resources to both the user of the Solaris™ platform and the user of the Windows® 98 platform, but does not have the luxury of being able to custom design its content for the individual traditional platforms.

Java™ technology was developed by Sun Microsystems to address this problem by providing a universal platform across the myriad combinations of operating systems and hardware that make up the Internet. Java™ technology shields programmers from the underlying OS/hardware variations through the Java™ Virtual Machine (JVM), a software-based computing entity that remains consistent regardless of the platform.

The cross-platform architecture of the Java™ programming language is illustrated in FIG. 2, which shows how the Java™ language enables cross-platform applications over the Internet. In the figure, the computer (2) running the Solaris™ platform and the computer (4) running the Windows® 98 platform are both provided with the JVM (10). The resource provider creates a Java™ application using the Java™ software development kit (“SDK”) (11) and makes the compiled Java™ byte codes available on the server (8), which in this example is running on a Windows NT® platform. Through standard Internet protocols, both the computer (2) and the computer (4) may obtain a copy of the same byte code and, despite the difference in platforms, execute the byte code through their respective JVM (10).

Java™ technology illustrates the most fundamental principle at work within the stack—the more stable and consistent the software layers are at the lower levels, the easier it is to develop programs at the higher levels. A reasonable extension to this principle is that the higher up the stack the concept of a platform extends, the more productive the programmers at the upper layers above it become. This is due to being insulated from the complexity below.

Therefore, effective programming at the application level requires the platform concept to be extended all the way up the stack, including all the new elements introduced by the Internet. Such an extension allows application programmers to operate in a stable, consistent environment.

iPlanet™E-Commerce Solutions, a Sun Microsystems|Netscape Alliance, has developed a net-enabling platform shown in FIG. 3 called the Internet Service Deployment Platform (ISDP) (28). ISDP (28) gives businesses a very broad, evolving, and standards-based foundation upon which to build an e-enabled solution.

ISDP (28) incorporates all the elements of the Internet portion of the stack and joins the elements seamlessly with traditional platforms at the lower levels. ISDP (28) sits on top of traditional operating systems (30) and infrastructures (32). This arrangement allows enterprises and service providers to deploy next generation platforms while preserving “legacy-system” investments, such as a mainframe computer or any other computer equipment that is selected to remain in use after new systems are installed.

ISDP (28) includes multiple, integrated layers of software that provide a full set of services supporting application development, e.g., business-to-business exchanges, communications and entertainment vehicles, and retail Web sites. In addition, ISDP (28) is a platform that employs open standards at every level of integration enabling customers to mix and match components. ISDP (28) components are designed to be integrated and optimized to reflect a specific business need. There is no requirement that all solutions within the ISDP (28) are employed, or any one or more is exclusively employed.

In a more detailed review of ISDP (28) shown in FIG. 3, the iPlanet™ deployment platform consists of the several layers. Graphically, the uppermost layer of ISDP (28) starts below the Open Digital Marketplace/Application strata (40).

The uppermost layer of ISDP (28) is a Portal Services Layer (42) that provides the basic user point of contact, and is supported by integration solution modules such as knowledge management (50), personalization (52), presentation (54), security (56), and aggregation (58).

Next, a layer of specialized Communication Services (44) handles functions such as unified messaging (68), instant messaging (66), web mail (60), calendar scheduling (62), and wireless access interfacing (64).

A layer called Web, Application, and Integration Services (46) follows. This layer has different server types to handle the mechanics of user interactions, and includes application and Web servers. Specifically, iPlanet™ offers the iPlanet ™ Application Server (72), Web Server (70), Process Manager (78), Enterprise Application and Integration (EAI) (76), and Integrated Development Environment (IDE) tools (74).

Below the server strata, an additional layer called Unified User Management Services (48) is dedicated to issues surrounding management of user populations, including directory (80), meta-directory (82), delegated administration (84), Public Key Infrastructure (PKI) (86), and other administrative/access policies (88). The Unified User Management Services layer (48) provides a single solution to centrally manage user account information in extranet and e-commerce applications. The core of this layer is iPlanet™ Directory Server (80), a Lightweight Directory Access Protocol (LDAP)-based solution that can handle more than 5,000 queries per second. For more information about iPlanet™ products, see the iPlanet™ documentation web site at http://docs.iplanet.com /docs/manuals/.

As part of the Web, Application, and Integration Services (46) layer of the iPlanet™ ISDP as shown in FIG. 3, iPlanet™ Process Manager (PM) (78) is a complete solution for developing, deploying, and managing automated business processes. PM (78) runs on top of iPlanet™ Application Server (72), and is suited for dynamic, unstructured processes that extend over an extranet or intranet and that require centralized management. PM (78) allows a user to create web-based applications that define the different tasks in a process, specify who should perform them, and map out how the process flows from one task to another. Consider the process for preparing an office for a new employee. Several different activities make up the process—assigning an office, ordering a computer, installing the telephone, installing the computer, and checking that the office furniture has been arranged properly. Some of these tasks need to be performed sequentially, for example, you must order the computer before installing it. Other tasks can be carried out in parallel, for example you don't need to wait for the computer to be ordered before installing the telephone. Different people perform different tasks—the purchasing department orders the computer, but the Information Systems department installs it when it arrives. Other examples of typical PM applications includes bidding processes for outside firms, processes for conducting structured negotiations with outside partners, a contractor management process, and applications for processing expense reimbursement requests.

The PM (78) environment consists of development, run-time, end-user, and management environments. The PM (78) is organized into several distinct components as shown in FIG. 4. The first is iPlanet™ Process Manager Builder (PMB) (91) followed by an iPlanet™ Process Manager Engine (92), iPlanet™ Process Manager Express (93), iPlanet™ Process Manager Administrator (94), the iPlanet™ Directory Server (80), and a standard relational database (97) and PM clusters (96). Each of these components is discussed in detail below.

The PMB (91) is a visual process design tool that is used to create and deploy PM applications that maps the steps in a business process. The PMB (91) allows enterprises to control which steps are included in a process and the sequence of those steps, and to embed business rules in the processes. Therefore, processes are efficient, reliable, and adhere to specific business policies. Using the PMB (91), which is a graphical user interface with drag and drop capability, a process application is built that controls the flow of a process. The process contains tasks, or workitems, that require human intervention, such as approving a purchase request, as well as activities that can be completely automated such as retrieving data from databases and writing log files.

Using a drag-and-drop tool bar, a visual process map (120), as shown in FIG. 5, is designed comprising a series of steps and the rules that transfer the flow of control from one step to another. The visual nature of the process map allows the modification of processes, even if the person doing the modification was not the original designer and has little knowledge of the process. Steps can be both manual (processed by people) or automated (through use of scripting or programming). The PMB (91) is where individuals, groups, or roles are assigned responsibility for the process steps. This assignment of responsibility is facilitated through the builder's tight integration with LDAP directory servers.

The PMB (91) is also used to develop Hypertext Markup Language (HTML) forms that serve as the process interface for end users. Forms can include client-side JavaScript for field input validation. Forms can also be extended by incorporating JavaBeans and applets that are used to encapsulate business logic. Forms and associated processes can have any number of documents attached to them using a file attachment object. Access to the forms and the various process data they contain is controlled via the iPlanet™ Process Manager Builder Forms Access grid.

Once the process definitions are developed in the PMB (91), the application is deployed. When PM application is deployed, three steps are performed. First, the application is written to the PM configuration directory. Next, the application is initialized on all iPlanet™ Process Manager Engines (92) in a PM cluster (96). Lastly, the tables are created in the relational database (97).

The iPlanet™ Process Manager Engine (92) runs inside the iPlanet™ Enterprise Server and hosts applications at run-time, including extranet applications. iPlanet™ Process Manager Engine (92) reads process definitions from LDAP-based directories and leverages the Simple Workflow Access Protocol (SWAP) to integrate with process automation solutions from different vendors and leverages iPlanet™ Enterprise Server scalability for extranet access. iPlanet™ Process Manager Engine (92) also integrates with any SMTP messaging server and uses clustering.

Access to established processes is accomplished through the iPlanet™ Process Manager Express (93), a browser-based HTML interface where users can access specific workitems, initiate new process instances, delegate workitems to others, and query the status of in-process workitems. A web-based work list (much like an in basket or to do list) is displayed to let a person know that a task has been assigned to them, as illustrated in FIG. 6. When the assignee is ready to perform the task, he or she clicks on the task name. iPlanet™ Process Manager Express displays a form that provides the data needed to perform the task, as illustrated in FIG. 7. When the assignee has performed the task, he or she enters any data needed to complete the task and then submits the form. The workitem automatically disappears from the assignee's work list. The process moves onto the next step and the next task shows up in the worklist of the appropriate person. iPlanet™ Process Manager Express (93) automatically performs any automated tasks that do not require human intervention.

The iPlanet™ Process Manager Administrator (94) is a web-based administrative console accessible via any standard web browser. The iPlanet™ Process Manager Administrator (94) serves two functions: (1) managing the PM cluster (96) (that includes, the iPlanet™ Process Manager Engines (92), the LDAP directory servers (95), and the relational database (97)); (2) monitoring and managing the deployed processes/applications that are installed on the clusters. FIG. 8 shows one of the administrative interfaces.

The iPlanet™ Directory Server (80) (or any other LDAP capable directory server) is used for process object definition storage as well as for resolution of roles at run-time. Storage of process objects in the directory allows for replication, broader distribution, and centralized management. PM applications are installed to iPlanet™ Process Manager Engines (92) from the iPlanet™ Directory Server (80).

A standard relational database (97) (Oracle® and Sybase® are supported) is used to store the state of process instances. PM applications are isolated from the process state database through the LiveWire database access API. PM delivers ease of administration by automatically defining the database table schema at the time that applications are loaded into the PM cluster (96), without the need for intervention by an administrator. This schema is constructed based on the data dictionary components that are defined at the time of development.

In a cluster configuration, multiple engines are connected to a single shared database. Because all iPlanet™ Process Manager Engines (92) access the same database server, and all are a persistent state is in the database, these engines function as a single logical server. This architecture gives PM its failover capability, because any engine in a cluster can serve a process in the event another engine in the PM cluster (96) fails. As previously noted, engines can be added to the PM cluster (96) for increased application scalability. Administrators can add engines to the PM cluster (96) without having to shut down applications, thereby ensuring continuity of service and further easing management.

PM (78) as shown in FIG. 4 is designed from the ground up to be web-centric. The forms that users access are based on HTML, and these web pages can be extended using JavaScript™, Java™ applets, JavaBeans™, and other customized components. Web browsers are the ideal platform for users of business processes because of broad deployment.

As a web application, PM (78) can be readily distributed among multiple servers in a network. With this approach, process participants can be connected together without the need for local proximity. The process participants are able to draw on a number of resources on an intranet or extranet to complete specific activities, and the participants also have access to a set of references and documents needed to complete the activity. Connectivity through the web also provides a ready mechanism for participants to have visibility into the status of in-process items.

PM (78) is based on widely adopted web standards and protocols and is designed to be browser-neutral with support for both Netscape™ Navigator and Microsoft® Internet Explorer. HTML is the standard for forms, and these forms can include any combination of text, graphics, and client-side scripting. Because the forms use HTML, pages produced by other editors can be imported in and incorporated into a process. PM (78) uses Hypertext Transfer Protocol (HTTP) as the standard transport protocol for browser access. Process extensions are implemented using JavaScript™ rather than a proprietary scripting language. Process definition objects are stored in LDAP-capable directories to allow for replication and distribution throughout an organization. At run-time, process participant roles are also resolved through LDAP-accessible organizational directories. In addition, process state information is stored in standard relational databases (97) rather than proprietary content stores.

The benefit of this standards approach is to facilitate ready deployment within organizations, and to allow for direct integration into the corporate infrastructure and with extranet partners. Most organizations have deployed web infrastructures (HTTP transport, web browsers) which can be directly leveraged. The broad deployment of LDAP as a directory access protocol allows for ready access to organizational hierarchy information. In addition, leveraging pre-existing infrastructure minimizes the need for retraining of systems support staff.

PM (78) is designed for extensibility using client- and server-side scripting using JavaScript™ functions. This provides a flexible environment for extended capabilities without the overhead of a complete programming environment. Intelligent HTML forms can include JavaScript™ expressions for field validation and checking. These forms can also include customized components for tasks like file transfer and directory lookup.

### SUMMARY OF INVENTION

In one aspect, a method of creating and defining a custom data field within a process management system includes creating a file to specify visible field properties of the custom data field and defining a model of the custom data field. In an embodiment, the file and the model are packaged into an archive file. In an embodiment, the custom data field is inserted and the archive file is added into the process management system as a new class. In an embodiment, the process management system is deployed with the new class. In an embodiment, the process management system is tested with the new class. In an embodiment, the model is a written class and at least two implemented interfaces and the model is an image created to depict the custom data field. In an embodiment, the class determines presentation and data management capabilities of the custom data field.

In another aspect, a method of creating and defining a custom data field within a process management system includes creating a file to specify visible field properties of the custom data field and defining a model of the custom data field. The file and the model are packaged into an archive file. The custom data field is inserted and the archive file is added into the process management system as a new class. The process management system is deployed with the new class. The process management system is tested with the new class.

In another aspect, an apparatus for creating and defining a custom data field within a process management system includes a file specifying visible field properties, a model, an archive file created by packaging the file and the model, and a new class created by inserting the custom data field and adding the archive file. In an embodiment, the model is an image created to depict the custom data field. In an embodiment, the model is a written class and at least two implemented interfaces. In an embodiment, the class determines presentation and data management capabilities of the custom data field.

In another aspect, a computer system includes a storage element comprising a process management system and a processor for creating and defining a custom data field within a process management system in the storage element. In an embodiment, a computer monitor is adapted to display the custom data field within the process management system. In an embodiment, an input device is adapted to enter data into the custom data field within the process management system.

In another aspect, an apparatus for creating and defining a custom data field within a process management system includes a means for creating a file to specify visible field properties of the custom data field, a means for defining a model of the custom data field, a means for packaging the file and the model into an archive file, a means for inserting the custom data field and adding the archive file into the process management system as a new class, a means for deploying the process management system with the new class, and a means for testing the process management system with the new class. In an embodiment, the model is an image created to depict the custom data field. In an embodiment, the model is a written class and at least two implemented interfaces. In an embodiment, the class determines presentation and data management capabilities of the custom data field.

Other aspects and advantages of the invention will be apparent from the following description and the appended claims.

### BRIEF DESCRIPTION OF DRAWINGS

FIG. 1 illustrates a multiple platform environment.

FIG. 2 illustrates a Java™ application running in a multiple platform environment.

FIG. 3 illustrates a block diagram of iPlanet™ Internet Service Development Platform.

FIG. 4 illustrates a block diagram of iPlanet™ Process Manager components.

FIG. 5 illustrates a computer screen shot of Process Manager Builder.

FIG. 6 illustrates a computer screen shot of Process Manager Express showing a work item list.

FIG. 7 illustrates a computer screen shot of Process Manager Express showing a specific work item.

FIG. 8 illustrates a computer screen shot of Process Manager Administrator.

FIG. 9 illustrates a typical computer with components relating to the Java™ virtual machine.

FIG. 10 illustrates a flowchart of the creation and definition of a custom data field in accordance with one embodiment of the invention.

FIG. 11 illustrates a computer screen shot of the Inspector Window with pre-defined properties in accordance with one embodiment of the invention.

FIG. 12 illustrates a tree diagram of the structure of BasicCustomField class in accordance with one embodiment of the invention.

FIG. 13 illustrates a flowchart of the how and when methods are called when a workitem or entrypoint is displayed in accordance with one embodiment of the invention.

FIG. 14 illustrates a flowchart of the how and when methods are called when a workitem or entrypoint is submitted in accordance with one embodiment of the invention.

FIG. 15 illustrates a computer screen shot of an example archive file for a custom data field in accordance with one embodiment of the invention.

FIG. 16 illustrates a computer screen shot of “Create a New Data Field” dialog box in accordance with one embodiment of the invention.

FIG. 17 illustrates a computer screen shot of “Select the field JAR Package” dialog box in accordance with one embodiment of the invention.

FIG. 18 illustrates a computer screen shot of the Inspector Window with custom properties in accordance with one embodiment of the invention.

FIG. 19 illustrates a computer screen shot of a custom data field in the form of a pop-up menu in accordance with one embodiment of the invention.

FIG. 20 illustrates a directory structure needed for the package structure for the custom data field in accordance with one embodiment of the invention.

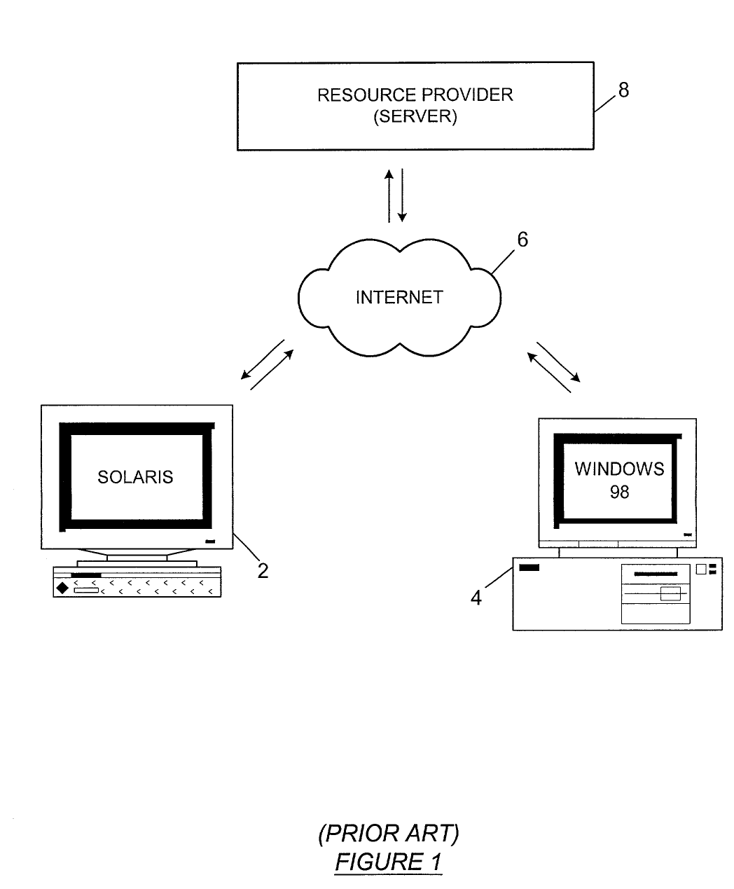

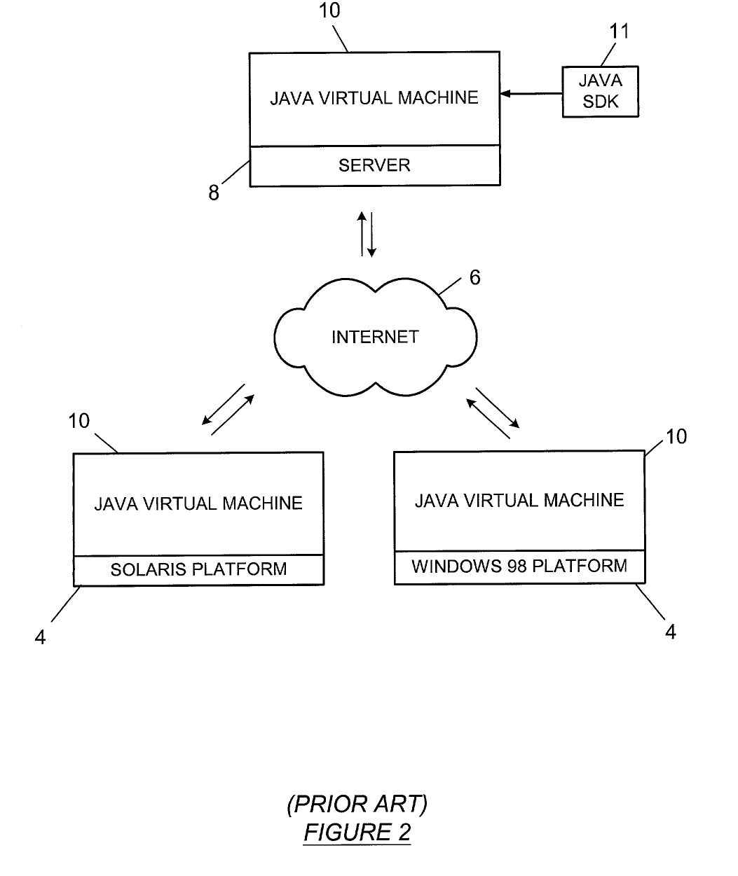

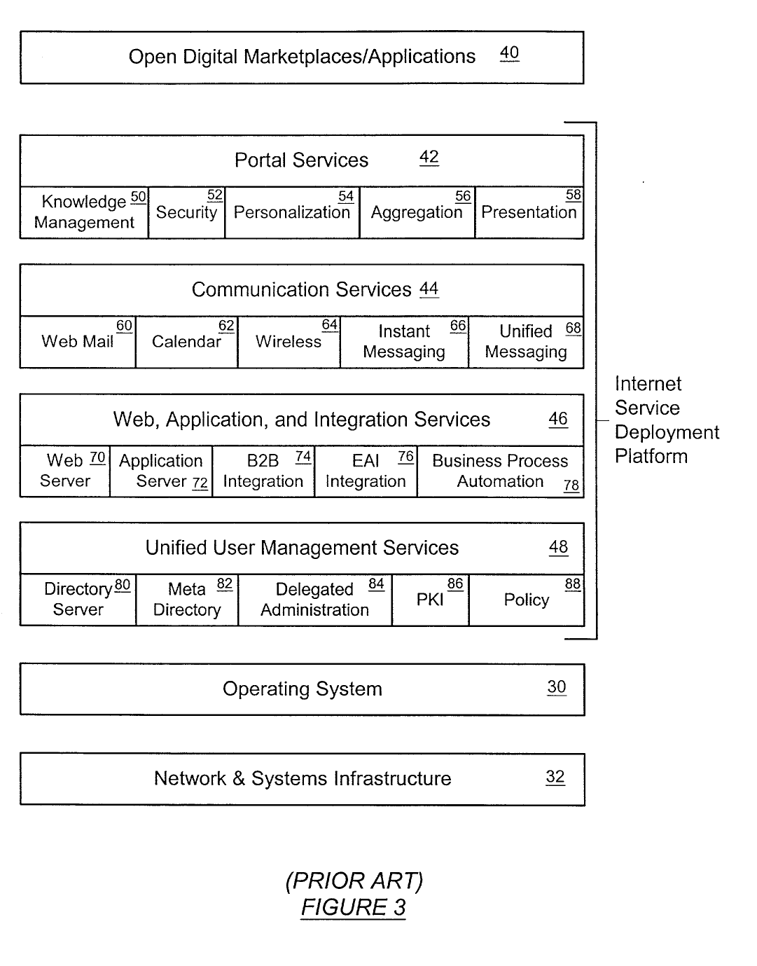

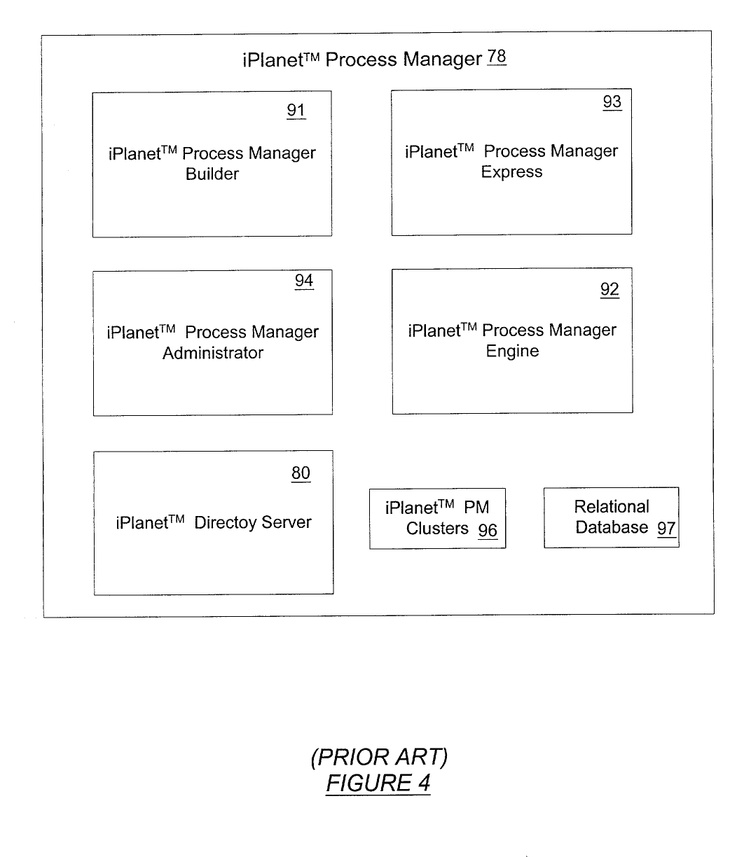

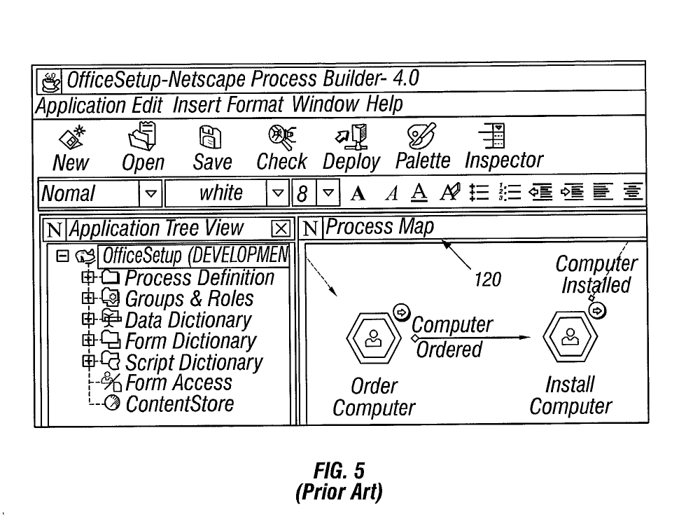

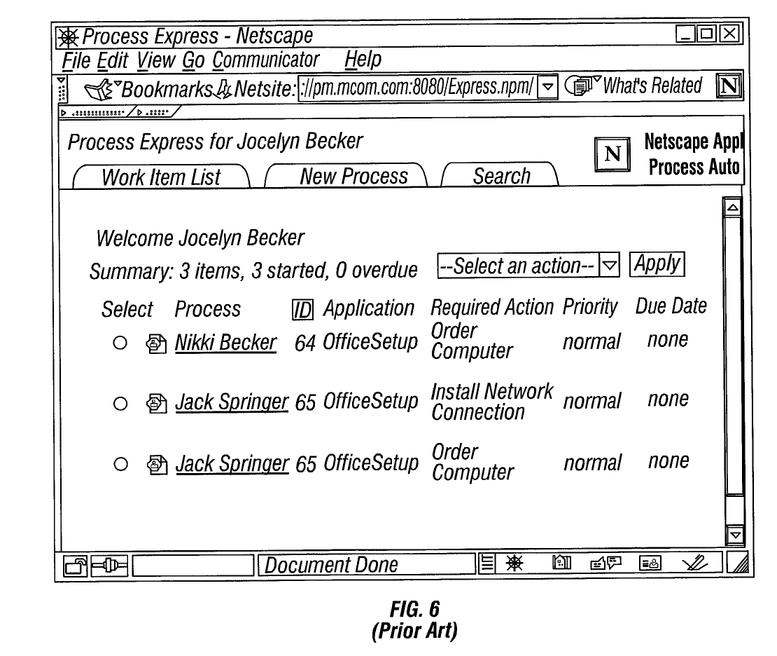

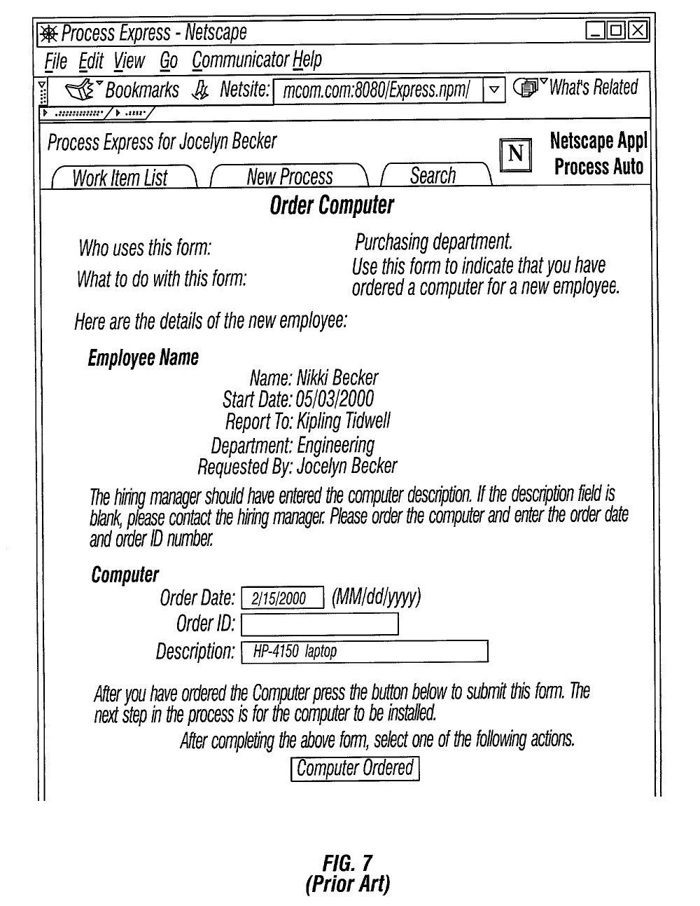

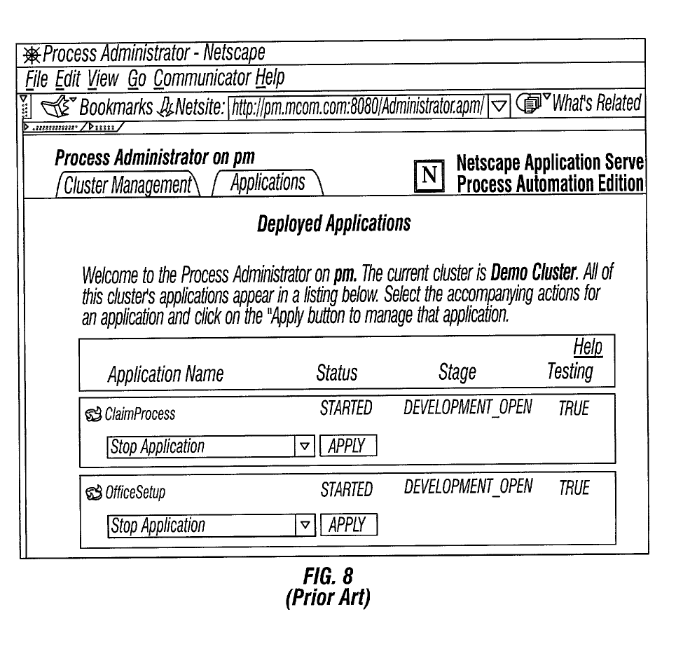

### DETAILED DESCRIPTION

Specific embodiments of the invention will now be described in detail with reference to the accompanying figures. Like elements in the various figures are denoted by like reference numerals for consistency.

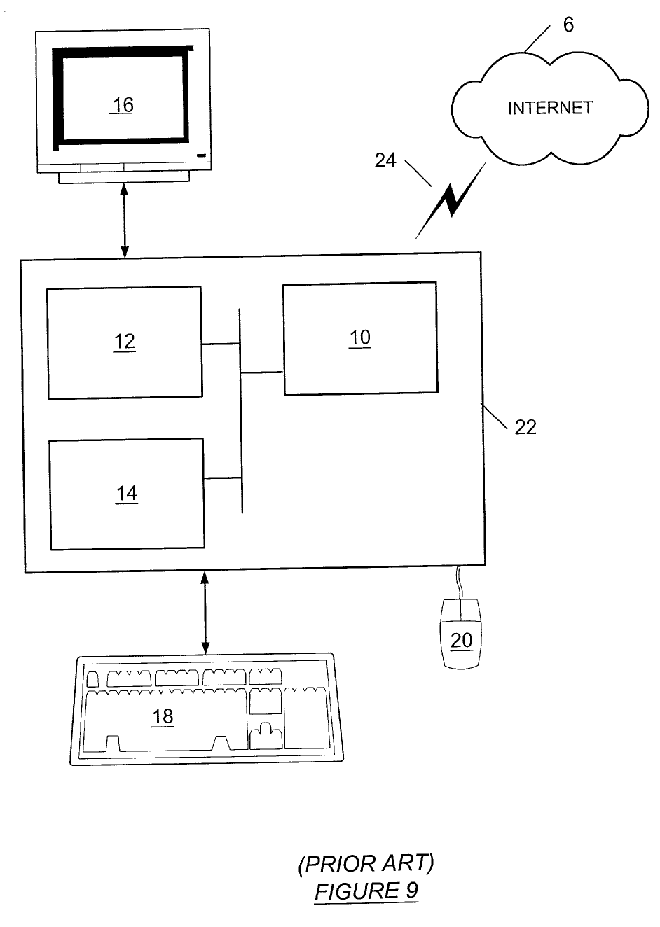

The invention described here may be implemented on virtually any type computer regardless of the platform being used. For example, as shown in FIG. 9, a typical computer (22) has a processor (12), associated storage element (14), and numerous other elements and functionalities typical to today's computers (not shown). The computer (22) has associated therewith input means such as a keyboard (18) and a mouse (20), although in an accessible environment these input means may take other forms. The computer (22) is also associated with an output device such as a display (16), which may also take a different form in an accessible environment. Computer (22) is connected via a connection means (24) to the Internet (6). The computer (22) is configured to run a virtual machine (10), implemented either in hardware or in software.

PMB (91) allows a user to do all tasks needed to build applications to control the flow of processes. The need to go outside the PMB (91) to build an application is infrequent. However, in some cases, the need exists to tweak applications. A process may require the use of a data field that is different from any of the built-in data sources. In these cases, custom data fields can be defined and created using Java™ APIs and JavaScript™. The process is then implemented into the PMB (91) to use when building an application.

A data field contains information relevant to a process instance, such as a maximum value of a budget or a name of a document. The data field stores a single value per data field. The PMB (91) offers a set of predefined data field classes, such as Radio Button and Textfield.

A custom data field, also known as entity fields, can be defined in situations where a necessary behavior needed is not provided by any of the predefined data field classes. Such situations may include numerous scenarios, such as: (1) supporting data types that are more complex than the data types available with built-in fields; (2) representing multi-dimensional values, or other high-level data objects, in a process. For example, custom data fields can represent a “shopping cart,” an account, or a service order; (3) accessing data objects that are stored in resources external to PM (78), such as PeopleSoft or CICS; and (4) displaying the data field differently in an entrypoint (where an entry point is a point at which a user can create a process instance) and a workitem (where a workitem is a task that requires human intervention).

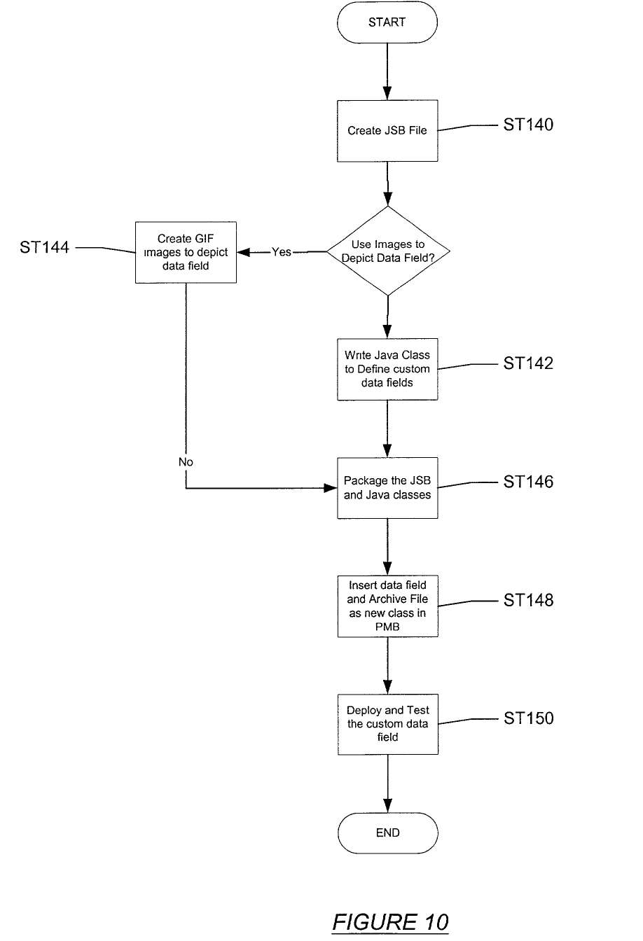

PM (78) allows definition of customized classes of data fields. Creating the custom data field involves several steps as shown in FIG. 10, starting with creating a JavaScript bean (JSB) file (step 140) to specify the visible field properties in PMB (91). The next step is writing a Java™ class to define the presentation and data management capabilities of the custom data field (step 142). At a minimum, two interfaces are implemented, IDataElement and IpresentationElement. Creating images to depict the data field in the PMB interface (step 144) is an option to writing a Java™ class and implementing the interfaces. The next step is packaging the JSB and Java™ classes into a zip or jar archive (step 146). Next, a data field is inserted and added the archive file as a new class in the PMB (91) (step 148). The last step is deploying the custom data field and testing the custom data field (step 150) becomes necessary after the custom data field is created and defined. Each step is described below in detail.

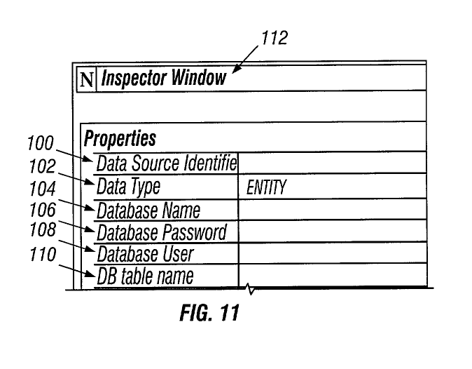

Defining field properties in the JSB file starts by creating the JSB file to define which of the custom data field properties can be set at design time in the PMB (91). In the PMB (91), these properties are visible through an Inspector window (112) as shown in FIG. 11. For each property shown in the Inspector window (112), a corresponding property is defined in the JSB file.

To create the JSB file for a new custom data field class, an existing JSB file is copied and modified to suit the needs of a user. For example, the JSB files for PM's (78) predefined data fields or a template JSB file is copied. The original JSB files for predefined data fields should not be modified, otherwise the data fields may no longer work. The JSB file and the custom data field class are assigned the same root file name with only the three letter extension varying. For example, a custom data field class named ShoppingCartField.class should have a JSB file named ShoppingCartField.jsb.

The JSB file has the following general structure:

<JSB>

<JSB_DESCRIPTOR . . . >

<JSB_PROPERTY . . . >

<JSB_PROPERTY . . . >

. . .

</JSB>

The JSB file is surrounded by an opening <JSB> tag and a closing </JSB> tag. A <JSB_DESCRIPTOR> tag specifies a NAME attribute, a DISPLAYNAME attribute, and a SHORTDESCRIPTION attribute of the data field class. The NAME attribute is the full path name for the data field class, using a dot (“.”) as a directory separator. The DISPLAYNAME attribute is the name that the PMB (91) uses for the field, such as the field's name in a Data Dictionary, where the Data Dictionary contains all fields used by the PM application. The SHORTDESCRIPTION attribute is a brief description of the field.

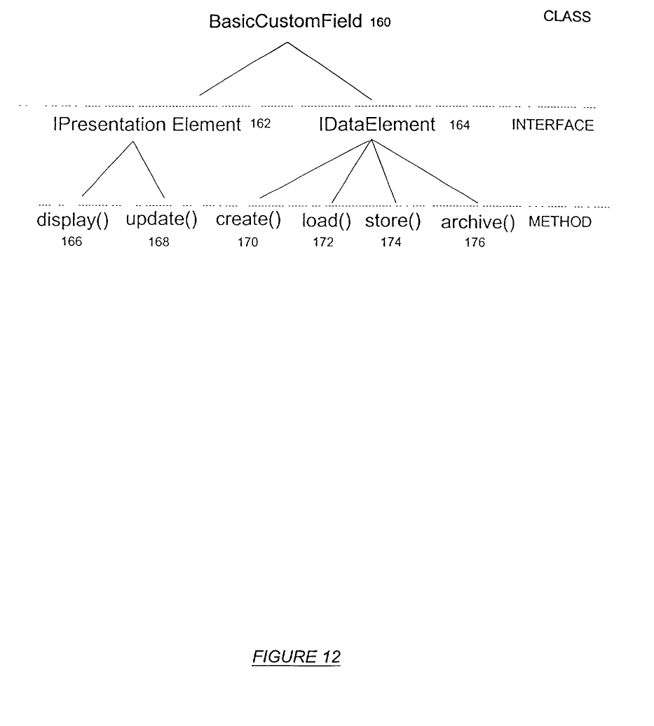

The JSB file contains a series of <JSB_PROPERTY> tags, one for each property that appears in the Inspector window (112). In one embodiment of this invention, the Inspector window (112) shows properties for data source identifier (100), database type (102), database name (104), database password (106), database user (108) and database table name (110) as shown in FIG. 12.

Each data field is required to have the properties listed in the table below:

| Property Name | Default Display Name | Purpose |
|---|---|---|
| cn | Name of this field | The common name of the data |
| | | field instance. (Note this is not |
| | | the name of the data field class.) |
| | | The name is set when you create |
| | | the data field in PMB. |
| description | Short Description | A description of the data |
| | | field. |
| prettyname | Display Name | The field’s display name, which |
| | | is the name that PMB uses for |
| | | the field. |
| help | Help Message | A help message for the field. |
| fieldclassid | Field Class ID | This is the package name of the |
| | | data field class. This is used |
| | | to ensure that each data field |
| | | type is unique. This value uses |
| | | the same convention as the |
| | | Java ™ naming |
| | | convention for packages. |
| fieldtype | Data Type | The datatype that the field uses |
| | | when it is stored in the PM |
| | | database. The value must be |
| | | ENTITY. |

In addition to these required properties, each data field can have properties that are specific to itself. For example, the Textfield data field class has properties for size and length, the Radio Button data field class has a property for options, etc. The purpose of the field is considered when defining the properties for the custom data field. For example, if the custom data field accesses an external database, connection properties should be defined. These properties may include the database type (Oracle® or Sybase®), a username and password, or a connection string. When the custom data field loads data from the external database, the custom data field may need a key to identify the data. This key, known as an entity key, is stored with the process instance

The properties defined in the JSB file may or may not be used depending on how a Java™ class interprets the properties. For example, the JSB file could contain a color property that is totally ignored in the Java™ class. In that case, no matter what color a designer defines for a field property, the defined property has no effect.

To write Java™ classes, the data that interacts with the classes should be examined closely. Two factors to examine are data types that the custom data field accepts (e.g., the format of the data or where the data originates) and data sources the custom data field is required to access (e.g., access a PeopleSoft or an SAP R/3 application or a relational database).

Custom data fields are stateless, so storage of information about a process instance from one workitem to another is impossible. A custom data field acts as a data manager. When a process instance arrives at the workitem, the data field receives data in the form of any Java™ object from an external data store. When the process instance leaves the workitem, the data field saves the data to an external store. The important idea is that the custom data fields specify only the logic to manage the data, not the data itself.

A BasicCustomField class (160) provides methods that enable PM (78) to treat the custom data field just like any other data field. Most of the methods in BasicCustomField (160) are predefined and are used internally by PM (78). BasicCustomField (160) implements a getPMApplication( ) method that returns IPMApplication that contains a name data field. Two other methods to return a name data field are a getName( ) method and a getPrettyName( ) method. The getName( ) method returns the name of the current element and is defined by the IPMElement interface. The getPrettyName( ) method returns the “pretty name” of the current element and is also defined by the IPMElement interface.

By creating a Java™ subclass of the BasicCustomField (160), a new data field class is implemented as shown in FIG. 12. The BasicCustomField class (160) implements an IpresentationElement interface (162) and an IDataElement interface (164). The IPresentationElement interface (162) specifies the presentation methods for the data field, which are a display( ) method (166) and an update( ) method (168). The IDataElement interface (164) specifies the methods for managing the loading and storing of data, which are a create( ) (170), a load( ) (172), a store( ) (174) and an archive( ) method (176). The new subclass provides definitions for each of the methods in these interfaces.

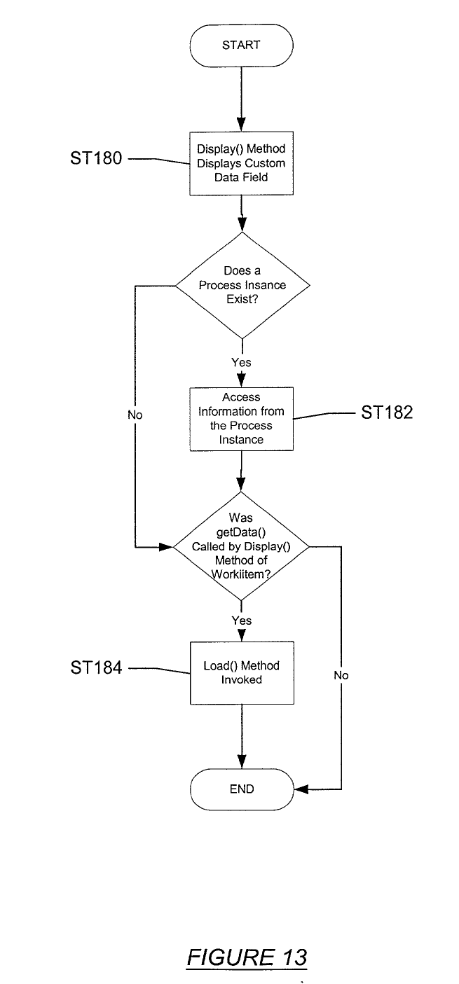

Before looking at the methods in detail, following is a discussion of how and when the methods are called. Referring to FIG. 13, when a form is displayed in the entrypoint or the workitem the following steps occur. First, the display( ) method (166) displays the custom data field (step 180). If the form is displayed in the entrypoint, the process instance does not yet exist, therefore the display( ) method (166) cannot access information about the process instance. If the form is displayed in the workitem, the process instance exists, therefore the display( ) method (166) accesses information about the process instance (step 182), such as the value of other data fields. Second, if the display( ) method (166) of the workitem calls the getData( ) function to get the value of the custom data field, then the load( ) method (172) is invoked (step 184).

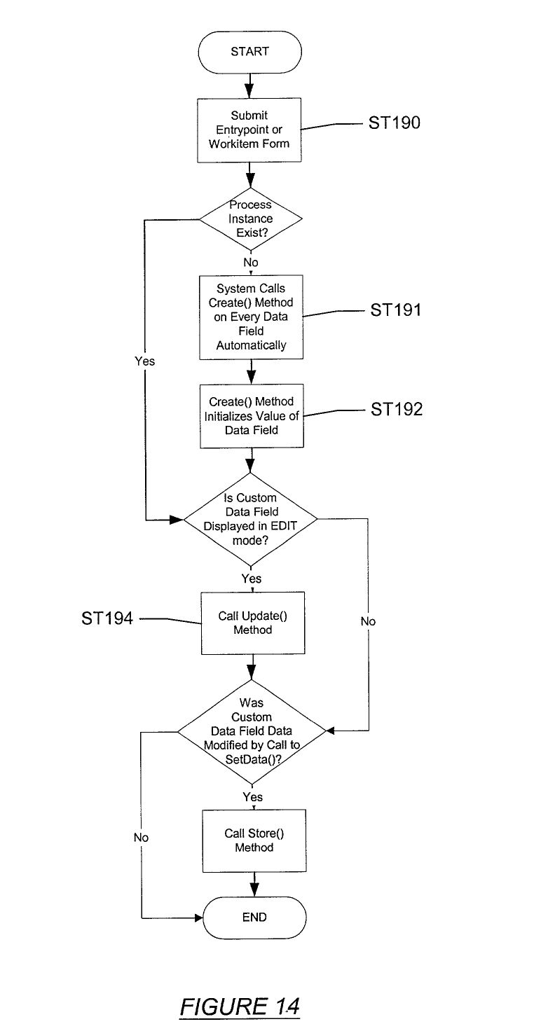

Referring to FIG. 14, when the entrypoint or workitem form is submitted (setp190), the following occurs. First, if the process instance is at the entrypoint, the system automatically calls the create( ) method (170) on every custom data field (step 191), regardless of whether the custom data field appears on the entrypoint form. The create( ) method (170) initializes the value of the custom data field (step 192). If the process instance is at the workitem, the process instance already exists, so the create( ) method (170) is not called. Second, if the form displays the custom data field in EDIT mode, the custom data field update( ) method (168) is called to update the custom data field on the process instance (step 194). The update( ) method (168) typically calls setData( ) to put the changed data into the custom data field. Lastly, if the custom data field's data was modified by a call to setData( ) (which might happen in the load( ), create( ) or update( ) methods), the system calls the store( ) method (174) to store the data (step 196).

A JavaScript™ script (for example, an automation script, assignment script or completion script) can use JavaScript™ functions getData( ) and setData( ) to get and set the data objects of a custom data field. In such a case, the invocation order is as follows. When the getData( ) function is called, the load( ) method is invoked to fetch the data unless it has already been loaded for the current activity. The load( ) method typically uses the setData( ) function to load the fetched data in to the data field. Whenever the setData( ) function is performed, the store( ) method is invoked when the process instance is ready to store itself. As a result, the store( ) method may be called even if the data field's data has not changed.

Definitions for the following methods are required in the new custom data field class on the subclass of BasicCustomField (160). A loadDataElementProperties( ) method processes the properties for the data field that are set in the PMB(91) and loads the design-time properties for the field specified in the Inspector window (112). Specified by BasicCustomField (160), custom data fields should implement this method.

The display( ) method (166) determines how the data field is displayed in an entrypoint or workitem form. This method displays the custom data field in the HTML page. When the custom data field is created both versions of this method must be implemented. This method is specified in the IPresentationElement interface (162).

The update( ) method (168) processes form element values when the entrypoint or workitem form is submitted. This method determines how the HTML representation of a custom data field is processed when a form is submitted. Typically, this method translates a form element value into the usual data object associated with the field. When creating a custom data field, this method must be implemented. This method is specified by the IPresentationElement interface (162).

The create( ) method (170) initializes the data field's value when the process instance is created. This method also initializes a newly created process instance with a default value for the custom data field. When a custom data field is created, this method must be implemented for the custom data field to have a default value in cases where the value does not appear on an entrypoint form. This method is defined by the IDataElement interface (164).

The load( ) method (172) loads the value of the data field when an attempt is made to retrieve the value of a data field for which no value has been set yet in the current workitem. When a custom data field is created, this method must be implemented. This method is specified by the IDataElement interface (164).

The store( ) method (174) stores the data field value externally and the data associated with the custom data field to a persistent resource. When a custom data field is created, this method must be implemented. This method is defined by the IDataElement interface (164).

The archive( ) method (176) archives the data field value by writing the data associated with the custom data field to an output stream. When a custom data field is created, this method must be defined if data field is intended to be archivable. This method is specified by the IDataElement interface (164).

Instead of creating a Java™ subclass and interfaces to implement a new data field class, images to represent data fields in the PMB (91) can be specified. The image that represents the data field in edit mode is named as dataFieldName-EDIT.gif. The image that represents the data field in view mode is named as dataFieldName-VIEW.gif. For example, for the myNewCustomField data field, the edit mode image is myNewCustomField-EDIT.gif, and the view mode image is myNewCustomField-VIEW.gif.

After the compilation of the custom data field Java™ classes, the JSB file and optionally created images to represent the data field in the PMB are defined. The next step is to package these files into a zip or jar archive. Any additional classes that the custom data field uses are included in the archive.

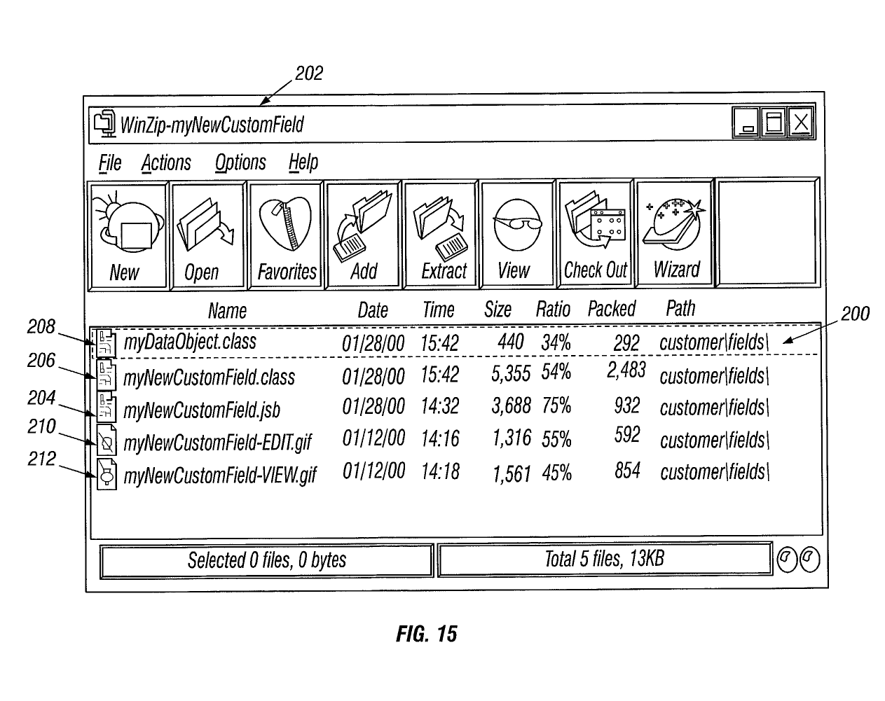

Referring to FIG. 15, packaging a custom data field starts with creating an archive in a utility application such as WinZip, PKZip, etc. The directory structure of the archive is checked to verify the directory structure reflects the package structure of the class. For example, if the class files are in the package customer.fields, the class files must be in the directory customer/fields (200), as shown in FIG. 15. The JSB file must be at the same level as the class files. Also, the archive file, JSB file, and custom data field class must all have the same root name. In the example shown in FIG. 15, this name is myNewCustomField.

FIG. 15 shows an example archive file for a custom data field called myNewCustomField (202). In this example, the data field is in a package customer.fields and the archive contains five files. myNewCustomField.jsb (204) is the JSB file for this custom data field. myNewCustomField.class (206) is the class file for this custom data field. myDataObject.class (208) is the class of data objects that are used as the custom data field values. myNewCustomField-EDIT.gif (210) and myNewCustomField-VIEW.gif. (212)are GIF image files that are used as icons to represent the data field in edit and view mode in the PMB (91).

When the jar command is used to create an archive, a file named manifest.mf is automatically created by default. This file contains information about the other files within the archive. The manifest.mf file has no effect on the custom data field.

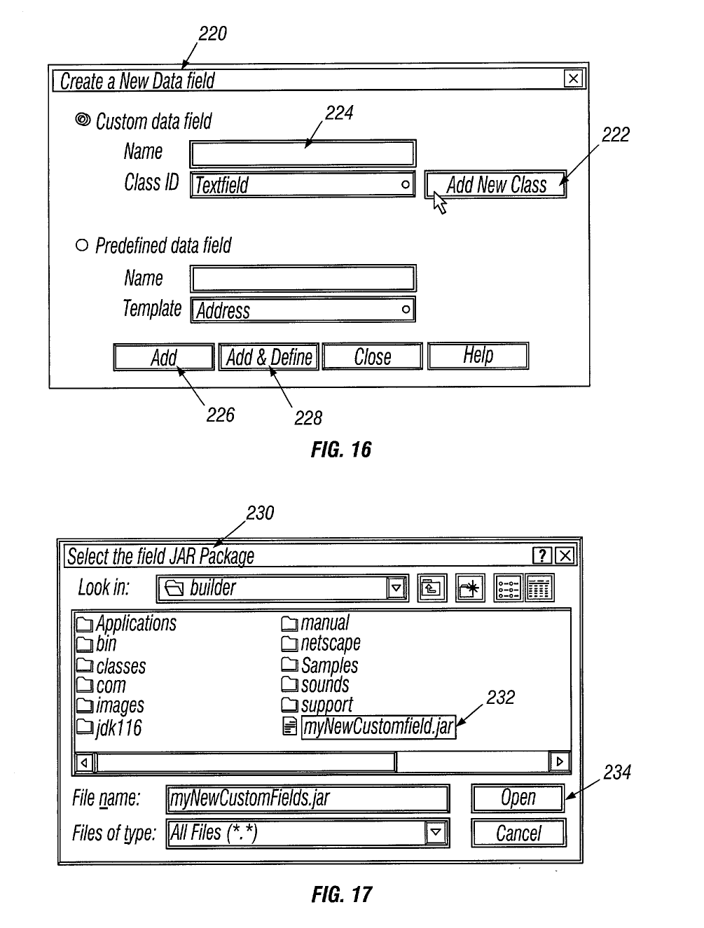

After packaging a custom datafield as an archive file, the field is added to the PMB (91). The specific steps for adding a custom data field are as follows. First, from the “Insert” menu, “Data Field” menu item is chosen. Next, in the “Create a New Data Field” dialog box (220) shown in FIG. 16, a “Add New Class” button (222) is clicked.

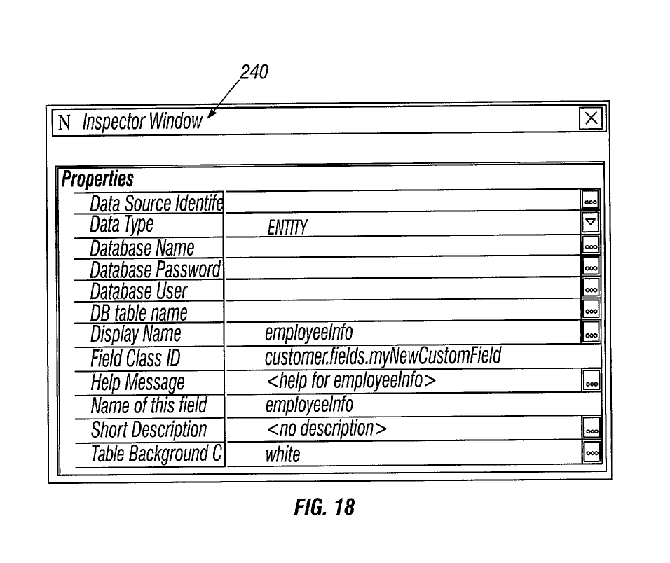

Referring to FIG. 17, in the “Select the field JAR Package” dialog box (230), the archive that represents your custom data field class is selected (myNewCustomField.jar (232) in this example), then an “Open” button (234) is clicked. Next, referring back to FIG. 16, in the “Name” field (224), the name of the new field is entered and added to the Data Dictionary in either of two ways. A first option is to click an “Add” button (226) to add the field without setting its properties. The dialog box (220) remains open, and more items can be added. A second option is to click an “Add & Define” button (228) to add the field and set the field properties immediately. The Inspector window (240) appears for the added data field, as shown in FIG. 18. Next, the properties are set and the window is closed when finished. The new custom data field, with the properties defined, now appears in the Data Dictionary folder in the application tree view. Now, the custom data field is available to use in the same manner as a typical data field in the PMB (91).

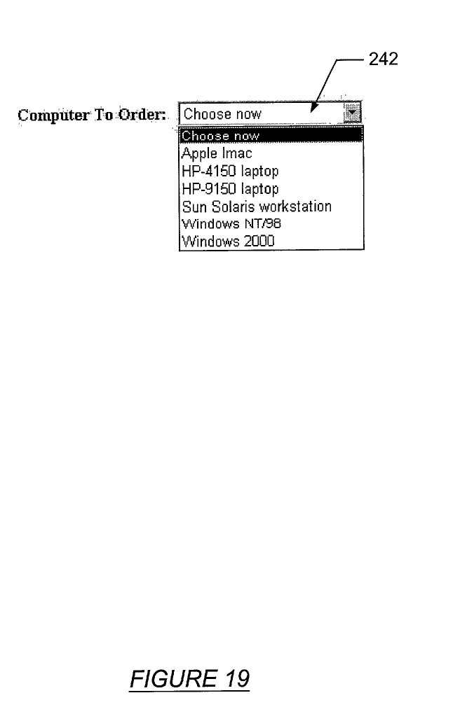

An example of a custom data field is an AdvancedOfficeSetup sample application that is typically shipped with the PMB (91). As shown in FIG. 19, the advanced office setup application uses a custom data field called dfComputerChoice that presents a pop-up menu (242) of computers that can be ordered for a new employee. This custom data field dynamically generates the list of computers every time it is displayed in edit mode. The custom data field generates the list by reading an XML file containing the choices. Whenever the company list of approved computers changes, all the administrator needs to do is to change the list in the XML file with no need to re-deploy the PM application.

To test and debug a custom data field, the PM application is imported into the PMB (91), the application is deployed and then tested. During the development process, changes are made to the Java™ source files and the classes are recompiled. Whether the application needs to be re-deployed or not depends on where the PM (78) is running. If the iPlanet™ Process Manager Engine (92) is running on the same computer where the Java™ development work is done, there is no need to re-deploy the application from the PMB (91). However, the Application Server (72) needs to be restarted.

If the iPlanet™ Process Manager Engine (92) is running on a remote computer, the application needs to be re-deployed each time changes are made to the Java™ classes for the custom data field. Before re-deploying, the changes must be copied into the appropriate places (as discussed next) in the Applications folder hierarchy.

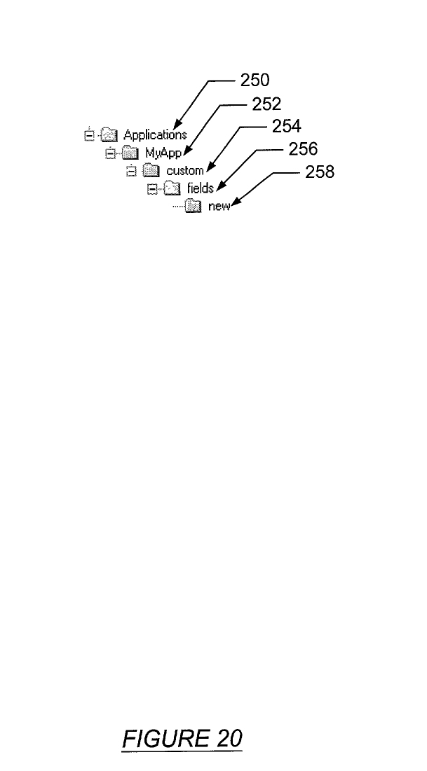

When using the PMB (91) to bring a zip or a jar file for the custom data field into the PM application, the PMB (91) unzips the zip or jar file and then creates the folders needed for the package structure for the custom data field. For example, if the application name is myApp and the custom data field is in the package custom.fields.new, the PMB (91) creates a folder called new (258) in a folder called fields (256) in a folder called custom (254) in the myApp folder (252) in the Applications directory (250), as illustrated in FIG. 20. The PMB (91) places the unzipped files into the appropriate folders, for example, it places the JSB and Java™ class file for the custom data field in the new folder. After making changes to the Java™ files, the compiled class files are copied into the appropriate folder beneath the Applications directory. If changes are made to the JSB file, the changes must also be copied to the appropriate folder beneath the Applications directory.

To test the changes, the application is re-deployed. When the changes are complete, a new zip or jar file is made so that the finished data field can be imported into other PM applications.

An IPMRequest class represents requests that are sent by the browser to the iPlanet™ Process Manager Engine (92) when a form is submitted. These requests contain the values of the form elements in the form. An IPMRequest object is automatically passed to the update( ) method (168) of a custom data field class. The update( ) method (168) accesses the IPMRequest object to extract form element values and to find the authenticated user.

In one embodiment of the application, the IPMRequest class has three methods. First, a getAuthenticatedUserId method gets the ID of the authenticated user who made the request. Next, a getParameter method gets the value of a parameter in the request string. Typically, the parameter is the name of a form element in the form that was submitted. This method is typically invoked by the update( ) method (168) of the custom data field to extract form element values. Last, a isParameterDefined method returns true if a parameter is defined in the query string sent by a form submission, otherwise returns false. The update( ) method (168) can use this method to test for the existence of a parameter before attempting to retrieve the value. For example, if the entrypoint form displays different data fields than the workitem form, the update( ) method (168) can test for the existence of particular data fields to determine if the form came from an entrypoint or a workitem.

An advantage of creating and defining custom data fields in PM is that a chosen process can be customized to include a data field other than pre-defined fields. The PM developer that needs a data field that is not found in the pre-defined set of data fields is able to create and define the exact custom field needed to develop a truly integrated, customized PM application. Another advantage with this invention is the versatility to write a Java™ class to determine the presentation and data management capabilities of the custom field or, optionally, to create graphical images to depict the data field in the PMB interface.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method of creating and defining a custom data field within a process management system, comprising:
creating a file to specify visible field properties of the custom data field; and
defining a model of the custom data field.

2. The method of claim 1, further comprising:
packaging the file and the model into an archive file.

3. The method of claim 1, further comprising:
inserting the custom data field and adding the archive file into the process management system as a new class.

4. The method of claim 1, further comprising:
deploying the process management system with the new class.

5. The method of claim 1, further comprising:
testing the process management system with the new class.

6. The method of claim 1, wherein the model is a written class and at least two implemented interfaces.

7. The method of claim 6, wherein the class determines presentation and data management capabilities of the custom data field.

8. The method of claim 1, wherein the model is an image created to depict the custom data field.

9. The method of claim 1, further comprising:
packaging the file and the model into an archive file;
inserting the custom data field and adding the archive file into the process management system as a new class;
deploying the process management system with the new class; and
testing the process management system with the new class.

10. A method of creating and defining a custom data field within a process management system, comprising:
creating a file to specify visible field properties of the custom data field;
defining a model of the custom data field;
packaging the file and the model into an archive file;
inserting the custom data field and adding the archive file into the process management system as a new class;
deploying the process management system with the new class; and
testing the process management system with the new class.

11. An apparatus for creating and defining a custom data field within a process management system, comprising:
a file specifying visible field properties;
a model;
an archive file created by packaging the file and the model; and
a new class created by inserting the custom data field and adding the archive file.

12. The apparatus of claim 11, wherein the model is an image created to depict the custom data field.

13. The apparatus of claim 11, wherein the model is a written class and at least two implemented interfaces.

14. The apparatus of claim 13, wherein the class determines presentation and data management capabilities of the custom data field.

15. A computer system, comprising,
storage element comprising a process management system; and
a processor for creating and defining a custom data field within a process management system in the storage element.

16. The system of claim 15, further comprising:
a computer monitor adapted to display the custom data field within the process management system.

17. The system of claim 15, further comprising:
an input device adapted to enter data into the custom data field within the process management system.

18. An apparatus for creating and defining a custom data field within a process management system, comprising:
means for creating a file to specify visible field properties of the custom data field;
means for defining a model of the custom data field;
means for packaging the file and the model into an archive file;
means for inserting the custom data field and adding the archive file into the process management system as a new class;
means for deploying the process management system with the new class; and
means for testing the process management system with the new class.

19. The apparatus of claim 18, wherein the model is an image created to depict the custom data field.

20. The apparatus of claim 18, wherein the model is a written class and at least two implemented interfaces.

21. The apparatus of claim 20, wherein the class determines presentation and data management capabilities of the custom data field.
